(19) United States
(12) Patent Application Publication
(10) Pub. No.: US 2022/0269446 A1
(43) Pub. Date: Aug. 25, 2022

(54) EXECUTING A JOB IN AN IMAGE FORMING APPARATUS IN ACCORDANCE WITH CHANGED JOB SETTING INFORMATION

(71) Applicant: KYOCERA Document Solutions Inc., Osaka-shi (JP)

(72) Inventor: Hirotaka SASAGURI, Osaka-shi (JP)

(21) Appl. No.: 17/676,980

(22) Filed: Feb. 22, 2022

(30) Foreign Application Priority Data
Feb. 22, 2021 (JP) 2021-026762

(51) Int. Cl. G06F 3/12

(52) U.S. Cl. CPC G06F 3/121; G06F 3/1259; G06F 3/1292; G06F 3/1253; G06F 3/1205

(57) ABSTRACT

The portable terminal device generates and displays job setting information, and an image forming apparatus captures and acquires the job setting information and executes a job in accordance with the job setting information. When a job is stopped due to a specific error caused by the job setting information, the image forming apparatus generates and displays error information of the specific error, a portable terminal device (a) captures and acquires the error information, (b) displays the acquired error information, (c) changes the job setting information according to a user operation on the portable terminal device, and generates and displays job setting information after the change, and the image forming apparatus captures and acquires the job setting information after the change and executes the job according to the job setting information after the change.

### INCORPORATION BY REFERENCE

This application is based upon, and claims the benefit of priority from, corresponding Japanese Patent Application No. 2021-026762 filed in the Japan Patent Office on Feb. 22, 2021, the entire contents of which are incorporated herein by reference.

### BACKGROUND

The present disclosure relates to an image forming system, an image forming apparatus, and a driver program.

In one system, a portable terminal generates and displays a QR code ® including print setting information, an image forming apparatus reads the QR code ®, specifies setting information included in the QR code ®, changes the setting information as necessary, and performs printing in accordance with the setting information.

### SUMMARY

An image forming system according to the present disclosure includes a portable terminal device for generating and displaying job setting information, and an image forming apparatus for capturing and acquiring the job setting information and executing a job in accordance with the job setting information. When the job is stopped due to a specific error caused by the job setting information, the image forming apparatus generates and displays error information of the specific error, and the portable terminal device (a) captures and acquires the error information, (b) displays the acquired error information, (c) changes the job setting information according to a user operation on the portable terminal device, generates and displays the job setting information after the change, and the image forming apparatus captures and acquires the job setting information after the change and executes the job according to the job setting information after the change.

An image forming apparatus according to the present disclosure includes an image capturing device, a display device, a job setting acquisition unit for acquiring job setting information by capturing the job setting information with the image capturing device, a controller for executing a job according to the acquired job setting information, and an error processing unit for generating error information of the specific error and displaying the error information on the display device when the job is stopped due to a specific error caused by the job setting information. The job setting acquisition unit captures and acquires the job setting information changed in accordance with the error information, and the controller executes a job in accordance with the changed job setting information.

A driver program according to the present disclosure causes a computer in a portable terminal device including an image capturing device, a display device, and an input device to operate as a driver that generates job setting information, captures and acquires the job setting information, and displays the information to an image forming apparatus that executes a job in accordance with the job setting information. The driver (a) captures and acquires error information, which is displayed when a job stops due to a specific error caused by the job setting information in the image forming apparatus, by the image capturing device, (b) displays the acquired error information, (c) changes the job setting information in accordance with a user operation on the input device, generates and displays the changed job setting information, thereby causing the image forming apparatus to capture and acquire the changed job setting information and execute the job in accordance with the changed job setting information.

### BRIEF DESCRIPTION OF THE DRAWINGS

FIG. 1 is a diagram showing a configuration of an image forming system according to an embodiment of the present disclosure.

FIG. 2 is a block diagram showing the configuration of the image forming apparatus 1 shown in FIG. 1.

FIG. 3 is a block diagram showing the configuration of the portable terminal device 2 shown in FIG. 1.

FIG. 4 is a diagram showing an example of a visible code of job setting information generated and displayed by the portable terminal device 2 shown in FIGS. 1 and 3.

FIG. 5 shows an example of a visible code of error information generated and displayed by the image forming apparatus 1 shown in FIGS. 1 and 2.

FIG. 6 is a diagram showing an example of error information displayed by the portable terminal device 2 shown in FIGS. 1 and 3.

### DETAILED DESCRIPTION

Hereinafter, embodiments of the present disclosure will be described with reference to the drawings.

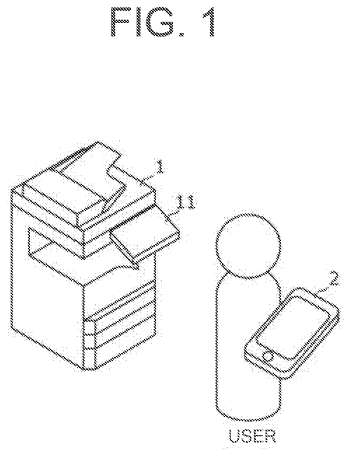

FIG. 1 is a diagram showing a configuration of an image forming system according to an embodiment of the present disclosure. The system shown in FIG. 1 includes an image forming apparatus 1 and a portable terminal device 2. The image forming apparatus 1 is an electronic device such as a printer or a multifunction peripheral, and includes an operation panel 11. The portable terminal device 2 is an electronic device such as a smartphone or a tablet PC carried by a user who uses the image forming apparatus 1.

In this system, the image forming apparatus 1 can be used by a plurality of users, and each of the users carries his or her portable terminal device 2. In some embodiments, some users may carry a plurality of the portable terminal devices 2.

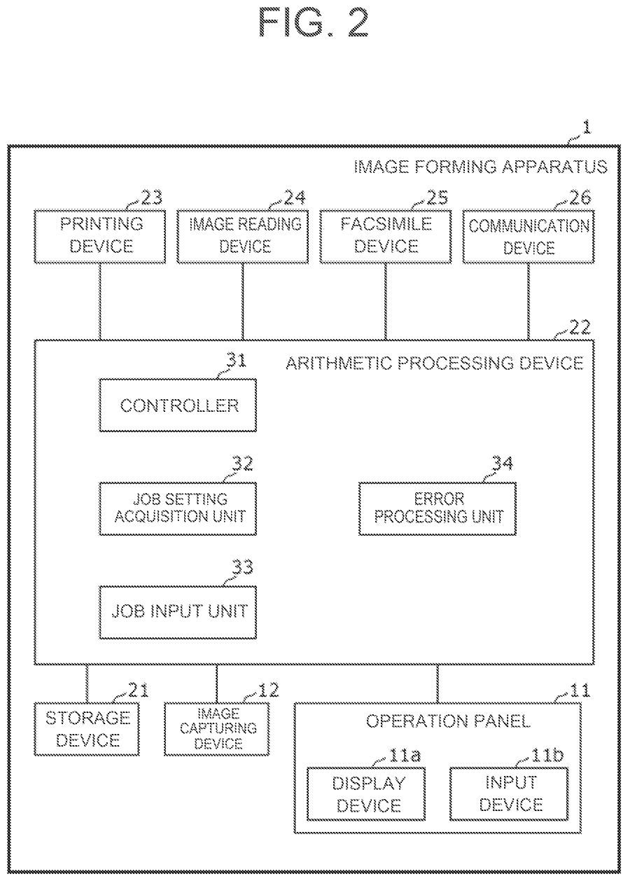

FIG. 2 is a block diagram showing the configuration of the image forming apparatus 1 shown in FIG. 1.

As shown in FIG. 2, in addition to the operation panel 11 described above, the image forming apparatus 1 includes an image capturing device 12, a storage device 21, an processing device 22, a printing device 23, an image reading device 24, a facsimile device 25, a communication device 26, and the like.

The operation panel 11 is disposed on the front side of the housing of the image forming apparatus 1 and includes a display device 11a such as a liquid crystal display and an input device 11b such as a hard key and a touch panel. The display device 11a displays various screens to the user. A soft key is implemented by a key image displayed on the display device 11a and a touch panel. The input device 11b receives a user operation on a hard key or a soft key input by the user.

The image capturing device 12 includes an optical system and an image sensor, and detects an image of a field of view of the optical system by the image sensor and outputs the image as image data. The image capturing device 12 is mounted on the operation panel 11, for example.

The storage device 21 is a nonvolatile rewritable storage device such as a flash memory.

The processing device 22 is a computer having a Central Processing Unit (CPU), a Read Only Memory (ROM), a Random Access Memory (RAM), or the like, and loads and executes programs from the storage device 21 or the ROM into the RAM to operate as various processing units. The processing device 22 operates as a controller 31, a job setting acquisition unit 32, a job input unit 33, and an error processing unit 34.

The printing device 23 prints an image specified by a print job request on a print sheet in accordance with the print job request based on a user operation. The image reading device 24 optically reads an original image from the original in accordance with a copy job request based on a user operation and then generates image data of the original image. The facsimile device 25 generates and transmits a facsimile signal of an image specified by a facsimile transmission job request in accordance with the facsimile transmission job request based on a user operation, and then receives the facsimile signal from outside and generates image data from the facsimile signal. The communication device 26 is a wireless or wired network interface or the like, and performs data communication with an external device (such as the portable terminal device 2).

The controller 31 controls internal devices such as the printing device 23, the image reading device 24, the facsimile device 25, and the communication device 26 to execute a job specified by the job request as described above. For example, when the controller 31 receives a print job request, the controller 31 causes the printing device 23 to print an image specified by the print job request, and when the controller 31 receives a copy job request, the image reading device 24 scans an original image according to the scan setting specified by the copy job request, and causes the printing device 23 to print the original image in accordance with the print setting specified by the copy job request.

The job setting acquisition unit 32 captures and acquires job setting information by the image capturing device 12. Specifically, the job setting acquisition unit 32 uses the image capturing device 12 to capture the visible code of the job setting information displayed on the portable terminal device 2, and decodes the visible code to acquire the job setting information.

When the job setting information is acquired by the job setting acquisition unit 32, the job input unit 33 inputs a job request based on the job setting information to the controller 31. The controller 31 executes a job (such as a print job) specified by the job request in accordance with the acquired job setting information.

The job setting information is setting information about various jobs, such as print jobs (that is, setting values specified by the user). In the case of a print job, the information of the image data storage location of the image to be printed (Uniform Resource Locator (URL), or a file path, for example) is included in the job setting information, and the job input unit 33 or the controller 31 acquires the image data based on the information and executes the print job based on the image data. In the case of a print job, the job setting information further includes setting values of at least one of predetermined setting items such as a paper feed cassette to be used, a paper discharge tray, a color/monochrome setting, a paper size setting, a duplex/simplex setting, and the like.

When the job is stopped due to a specific error caused by the above-described job setting information, the error processing unit 34 generates error information of the specific error and displays it on the display device 11a. After the display of the error information is started, the job setting acquisition unit 32 captures and acquires the job setting information changed in accordance with the error information in the same manner as in the above-described embodiments, and the controller 31 executes the job in accordance with the changed job setting information in the same manner as in the above-described embodiments.

Specifically, the error processing unit 34 encodes the above-described error information to generate a visible code and displays the generated visible code on the display device 11a.

In the present embodiment, the error information includes options of setting values in the job setting information for eliminating the cause of the specific error, and the job setting information after the change includes any of the options as setting values.

That is, when a setting value of a certain setting item in the job setting information causes a specific error, an option for an appropriate setting value is presented based on the error information, the setting value of the setting item is changed to an option specified by the user, and the job setting information after the change is acquired from the portable terminal device 2 by the image forming apparatus 1 (specifically by the job setting acquisition unit 32 in the present embodiment).

In this embodiment, the job setting information and the error information, which are described above, are displayed as visible codes, and the visible codes may be two dimensional codes such as QR codes ® or one dimensional bar codes. In this embodiment, the QR code ® is used as a visible code for the job setting information and the error information, which are described above.

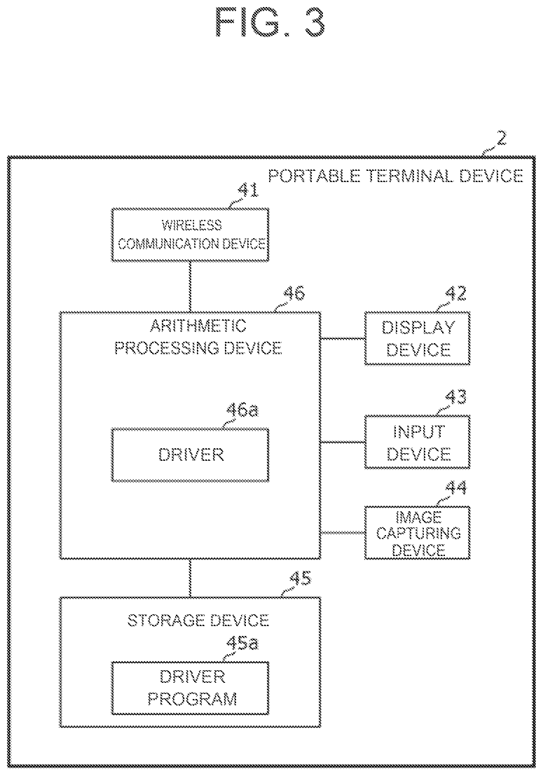

FIG. 3 is a block diagram showing the configuration of the portable terminal device 2 in FIG. 1.

The portable terminal device 2 includes a wireless communication device 41, a display device 42, an input device 43, an image capturing device 44, a storage device 45, an arithmetic processing unit 46, and the like.

The wireless communication device 41 is a communication circuit of a predetermined wireless communication standard. The wireless communication device 41 is a wireless LAN interface and/or an interface of a mobile telephone communication network (an RF interface, a baseband unit, and the like).

The display device 42 is a device such as a liquid crystal display disposed in the case of the portable terminal device 2 and displays various screens to the user. The input device 43 is a device for detecting a user operation and includes a touch panel, a hard key, and the like arranged on the display device 42. The image capturing device 44 includes an optical system and an image sensor, and detects an image of a field of view of the optical system by the image sensor and outputs the image as image data.

The storage device 45 is a nonvolatile storage device such as a flash memory, and stores programs and data. The storage device 45 stores a driver program 45a and the like.

The arithmetic processing unit 46 is a computer having a CPU, an ROM, an

RAM or the like, which loads and executes programs from the storage device 45 or the ROM into the RAM, and operates as various processing units. In this embodiment, the arithmetic processing unit 46 operates as the driver 46a by executing the driver program 45a.

The driver 46a generates job setting information for the image forming apparatus 1 in accordance with a user operation on the input device 43 and displays the job setting information (with respect to the image forming apparatus 1).

Further, the driver 46a (a) captures and acquires, by the image capturing device 44, error information displayed when the job is stopped due to a specific error caused by the job setting information in the image forming apparatus 1, (b) displays the acquired error information on the display device 42, (c) changes the job setting information according to a user operation on the input device 43, generates and displays the changed job setting information, thereby causing the image forming apparatus 1 to capture and acquire the changed job setting information and execute the job according to the changed job setting information.

As described above, in this embodiment, the error information includes options for setting values in the job setting information for eliminating the cause of the specific error, and the driver 46a selects one of the options in accordance with a user operation on the input device 43, and changes the setting value causing the specific error with the setting value of the selected option.

In this embodiment, the job setting information and the error information are displayed as visible codes, that is, in a visible manner, and the driver 46a encodes the job setting information, generates a visible code, displays the code on the display device 42, captures the visible code of the error information displayed on the image forming apparatus 1 by the image capturing device 44, and decodes the visible code to acquire the error information.

Next, the operation of the image forming system will be described.

First, when the image forming apparatus 1 executes a job, the user operates the portable terminal device 2 to generate and display job setting information. At this time, in the portable terminal device 2, the driver 46a specifies a user-desired setting value for one or a plurality of setting items based on a user operation on the input device 43, and generates job setting information including the setting value. Then, the driver 46a encodes the job setting information to generate a visible code, and displays it on the display device 42.

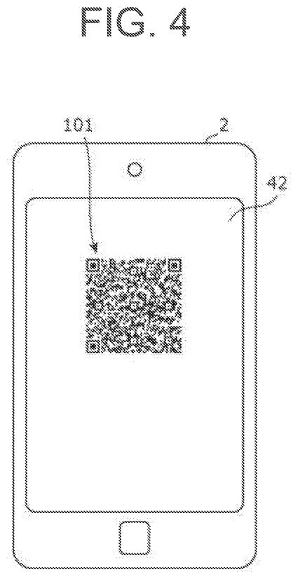

FIG. 4 is a view showing an example of a visible code of job setting information generated and displayed by the portable terminal device 2 shown in FIGS. 1 and 3. For example, as shown in FIG. 4, a visible code 101 of the job setting information is displayed.

Next, the user moves the portable terminal device 2 while the visible code 101 of the job setting information is displayed so that the visible code 101 is located within the field of view (angle of view) of the image capturing device 12 of the image forming apparatus 1.

On the other hand, in the image forming apparatus 1, the image capturing device 12 repeats at a predetermined capturing rate (for example, once every second) to capture the field of view (angle of view) of the image capturing device 12 to generate a captured image (image data) and output it to the job setting acquisition unit 32, and the job setting acquisition unit 32 monitors the captured image of the image capturing device 12, and when a visible code 101 is detected in the captured image, the visible code 101 is decoded to acquire job setting information, and the job input unit 33 inputs a job request based on the job setting information to the controller 31.

The controller 31 analyzes the job request (the above-mentioned set value or the like), and when it is determined that the job specified by the job request can be executed, the controller 31 executes the job using an internal device such as the printing device 23.

On the other hand, when the controller 31 determines that the job specified by the job request is not executable, the controller 31 identifies the cause of the error based on the result of the above-described analysis, and when the cause of the error is a specific cause of the error, the controller 31 identifies a setting item as the cause of the error and an appropriate setting value for the setting item. Then, the error processing unit 34 generates error information indicating the cause of the error and an option of an appropriate setting value, decodes the error information to generate a visible code, and displays the visible code on the display device 11a.

The appropriate setting value for the setting item causing the error is stored in the storage device 21 as a database or the like in advance, and the controller 31 reads out the appropriate setting value for the setting item causing the error from the storage device 21.

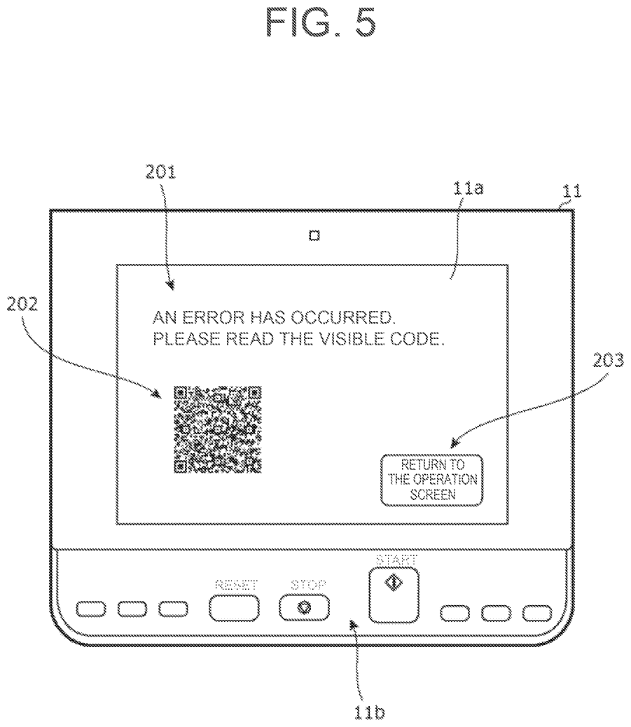

FIG. 5 shows an example of a visible code of error information generated and displayed by the image forming apparatus 1 shown in FIGS. 1 and 2.

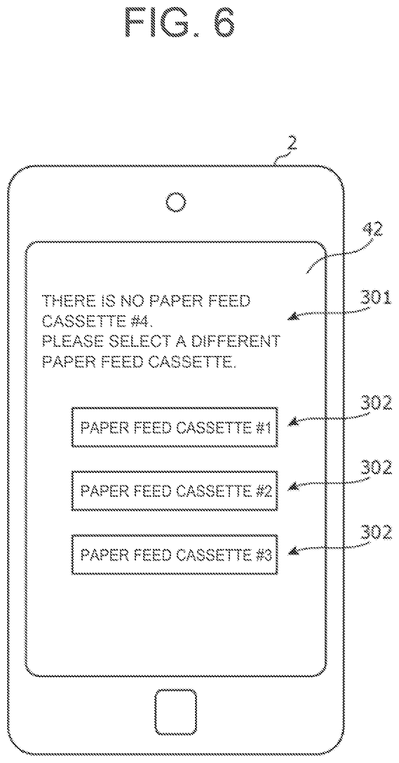

When the job is stopped due to an error, for example, as shown in FIG. 5, the error processing unit 34 displays an error occurrence message 201, the above-described visible code 202, and the soft key 203 on the display device 11a. The soft key 203 is a key for displaying an operation screen for error recovery on the display device 11a. When the soft key 203 described above is pressed, an operation screen similar to that shown in FIG. 6 described later is displayed on the display device 11a.

Then, the user moves the portable terminal device 2 while activating the driver 46a so that the visible code 202 is located within the field of view (angle of view) of the image capturing device 44 of the portable terminal device 2.

On the other hand, in the portable terminal device 2, the image capturing device 44 repeats at a predetermined capturing rate (for example, once every second) to capture the field of view (angle of view) of the image capturing device to generate a captured image (image data) and output it to the driver 46a, and the driver 46a monitors the captured image of the image capturing device 44, and when a visible code 202 is detected in the captured image, the visible code 202 is decoded to obtain error information, and the error information is displayed on the display device 42.

FIG. 6 is a diagram showing an example of error information displayed by the portable terminal device 2 shown in FIGS. 1 and 3. For example, as shown in FIG. 6, based on the error information, the driver 46a displays an operation screen including an error cause message 301 and an option 302 of an appropriate setting value, on the display device 42. Here, the option 302 is implemented with a soft key.

Then, the user operates the input device 43 to select one of the options 302 (for example, with pressing one of the options 302) on the operation screen of the error information. For example, in the operation screen shown in FIG. 6, the cause of the error is that a paper feed cassette (paper feed cassette #4) which does not exist in the image forming apparatus 1 is specified as a paper feed source in the job setting information for the print job, and the option of an appropriate setting value is a paper feed cassette (paper feed cassettes #1 to #3) which exists in the image forming apparatus 1.

Then, based on the user operation detected by the input device 43, the driver 46a of the portable terminal device 2 specifies an option 302 which the user desires, changes the setting value of the error cause to the setting value of the option 302 to regenerate the job setting information, decodes the job setting information to generate a visible code, and displays it on the display device 42.

The user moves the portable terminal device 2 so that the displayed visible code is located within the field of view (angle of view) of the image capturing device 12 of the image forming apparatus 1. In the image forming apparatus 1, in the same manner as in the case of the visible code 101, when the job setting acquisition unit 32 detects the visible code in the captured image of the image capturing device 12, the visible code is decoded to acquire job setting information, and the job input unit 33 inputs a job request based on the job setting information, to the controller 31. The controller 31 executes a process similar to that described above for the job request.

As described above, according to the above embodiment, the portable terminal device 2 generates and displays job setting information, and the image forming apparatus 1 captures and acquires the job setting information and executes a job in accordance with the job setting information. When a job is stopped due to a specific error caused by the job setting information, the image forming apparatus 1 generates and displays error information of the specific error, and the portable terminal device 2 (a) captures and acquires the error information, (b) displays the acquired error information, (c) changes the job setting information according to a user operation on the portable terminal device 2, and generates and displays job setting information after the change, and the image forming apparatus 1 captures and acquires the job setting information after the change and executes the job according to the job setting information after the change.

Thus, since it is possible to eliminate the cause of the error and restart the job without touching the operation panel 11 of the image forming apparatus 1 with respect to the specific error (setting value error in the job setting information or the like), there is less opportunity for the user to touch the operation panel of the image forming apparatus 1 for eliminating the cause of the error and restarting the job.

In an image forming apparatus of related arts used by a plurality of users, since a plurality of users may touch the operation panel, there is a possibility that contact infection such as a viral infection may occur through the operation panel. In one system, a portable terminal device generates and displays a QR code ® including print setting information, an image forming apparatus reads the QR code ®, specifies setting information included in the QR code ®, changes the setting information as necessary, and performs printing in accordance with the setting information. In this system, although the user can cause the image forming apparatus to start printing without touching the operation panel of the image forming apparatus by operating the portable terminal device, if an error occurs in the image forming apparatus and printing stops, it is necessary to touch the operation panel of the image forming apparatus in order to eliminate the cause of the error and to restart printing, which may be undesirable.

For example, when an error occurs due to a setting error or the like other than an error cause in which physical contact with an image forming apparatus is indispensable such as in a case requiring a consumable supply of paper or toner or due to a paper jam, the error cause can be eliminated only by a user operation such as a setting change, but as described above, it is necessary to touch the operation panel of the image forming apparatus, which may be undesirable.

As described above, the embodiments according to the present disclosure can reduce the opportunity of touching the operation panel of the image forming apparatus to eliminate the cause of the error and to restart the job. That is, according to the present disclosure, it is possible to obtain an image forming system which reduces chances of touching the operation panel of the image forming apparatus in order to eliminate the cause of an error or restart a job, and an image forming apparatus and a driver program usable for the image forming system.

Various changes and modifications to the above-described embodiments will be apparent to those skilled in the art. Such changes and modifications may be made without departing from the spirit and scope of the subject matter and without diminishing the intended advantages. That is, such changes and modifications are intended to fall within the scope of the claims.

For example, in the above-described embodiment, the job setting information may include job setting information or identification information unique to the portable terminal device 2, the error processing unit 34 may include the identification information (job setting information of a stopped job or identification information corresponding to the portable terminal device 2) in the error information, and the driver 46a of the portable terminal device 2 may execute a process corresponding to the error information (display of the error information, change of the setting, display of a visible code after the change, and the like) as described above when the identification information is included in the error information, and may not execute a process corresponding to the error information as described above when the identification information is not included in the error information (for example, in the case of error information for a job of another portable terminal device 2).

In the above embodiment, the error information includes an error code specific to the error cause, and the driver 46a of the portable terminal device 2 may convert the error code into an error message as shown in FIG. 6, for example, and display the error message.

In the above embodiment, the driver program 45a may be stored on a non-transitory computer-readable recording medium and installed from the recording medium to the storage device 45 of the portable terminal device 2.

What is claimed is:

1. An image forming system comprising:
a portable terminal device that generates and displays job setting information;
and
an image forming apparatus that captures and acquires the job setting information and executes a job in accordance with the job setting information;
wherein when the job is stopped due to a specific error caused by the job setting information, the image forming apparatus generates and displays error information of the specific error,
wherein the portable terminal device (a) captures and acquires the error information, (b) displays the acquired error information, and (c) changes the job setting information according to a user operation on the portable terminal device, and generates and displays the changed job setting information, and
wherein the image forming apparatus captures and acquires the changed job setting information, and executes the job according to the changed job setting information.

2. The image forming system of claim 1, wherein
the error information includes options of setting values in the job setting information for eliminating a cause of the specific error, and
the changed job setting information includes any one of the options as a setting value.

3. The image forming apparatus according to claim 2, wherein
the job setting information and the error information are displayed as visible codes.

4. An image forming apparatus comprising:
an image capturing device;
a display device;
a job setting acquisition unit that acquires job setting information by capturing the job setting information with the image capturing device;
a controller that executes a job in accordance with the acquired job setting information; and
an error processing unit that, when the job is stopped due to a specific error caused by the job setting information, generates error information of the specific error and displays the error information on the display device,
wherein the job setting acquisition unit captures and acquires the job setting information changed in accordance with the error information, and
wherein the controller executes the job according to the changed job setting information.

5. The image forming apparatus according to claim 4, wherein
the error information includes options of setting values in the job setting information for eliminating a cause of the specific error, and
the changed job setting information includes any one of the options as a setting value.

6. The image forming apparatus according to claim 5, wherein
the job setting information and the error information are displayed as visible codes.

7. A driver program configured to:
cause a computer in a portable terminal device including an image capturing device, a display device, and an input device to operate as a driver generating job setting information, capturing and acquiring the job setting information, and displaying the job setting information to an image forming apparatus that executes a job according to the job setting information;
wherein the driver (a) captures and acquires, with the image capturing device, error information displayed when a job is stopped due to a specific error caused by the job setting information in the image forming apparatus, (b) displays the acquired error information, (c) changes the job setting information in accordance with a user operation on the input device, generates and displays the changed job setting information, thereby causing the image forming apparatus to capture and acquire the changed job setting information and execute the job in accordance with the changed job setting information.

8. The driver program according to claim 7, wherein
the error information includes options of setting values in the job setting information for eliminating a cause of the specific error, and
the changed job setting information includes any one of the options as a setting value.

9. The driver program according to claim 8, wherein the job setting information and the error information are displayed as visible codes.
